(19) United States
(12) Patent Application Publication
(10) Pub. No.: US 2013/0107666 A1
(43) Pub. Date: May 2, 2013

(54) Method And System For Identifying Events Of Digital Signal

(71) Applicants: China Petroleum & Chemical Corporation, Beijing (CN); Sinopec Geophysical Research Institute, Nanjing City (CN)

(72) Inventors: Zhicheng LIU, Nanjing City (CN); Jin'e XIE, Nanjing City (CN); Zhaotao XU, Nanjing City (CN); Huiyu ZHANG, Nanjing City (CN); Jiexiong CAI, Nanjing City (CN)

(73) Assignees: SINOPEC GEOPHYSICAL RESEARCH INSTITUTE, Nanjing City (CN); CHINA PETROLEUM & CHEMICAL CORPORATION, Beijing (CN)

(21) Appl. No.: 13/662,360

(22) Filed: Oct. 26, 2012

(30) Foreign Application Priority Data
Oct. 26, 2011 (CN) 201110330622.7

(51) Int. Cl. G01V 1/28

(52) U.S. Cl. 367/48

(57) ABSTRACT

The present application relates to a method for identifying events of digital signal. The method identifies the events of a digital signal by means of the characteristic that the events of a digital signal basically depend on the signal phase.

### CROSS REFERENCE TO RELATED APPLICATION

This application claims priority to Chinese Patent Application No. 201110330622.7 filed on Oct. 26, 2011, which is hereby incorporated by reference herein in its entirety.

### FIELD OF INVENTION

The present disclosure relates to the field of digital signal processing.

### BACKGROUND

Identification and tracking of events in digital signals have always been very important in the technical field of digital signal processing. For example, in seismic prospecting, most of the information carried by seismic signals are substantially included in the events, so identification and tracking of events in seismic signals are closely associated with the processing and interpretation of seismic information.

Nowadays, more and more methods for identifying events of digital signal have been developed, such as method for AR automatic tracking, method for wavelet analyzing and CB morphological filtering, method for detecting events by using chaos operators, method of edge detection, method for identifying events by using artificial neural networks, method for identifying events by self-organizing neural networks, method for simulating singularity of signals, method of Pattern Recognition, C3 coherence algorithm, chain matching algorithm, and method for detecting image edge, etc.

However, the existing methods for tracking events of digital signal cannot achieve a desired effect of identification when the digital signals have low signal-to-noise ratio. That is to way, when the digital signals to be identified have low signal-to-noise ratio, the existing method for tracking events of digital signal cannot accurately distinguish events from noises.

### SUMMARY OF THE INVENTION

The present disclosure provides a novel method and device for identifying events (such as but not limited to syncphase axis) of digital signal. The method of the present disclosure identifies the events based on a time-distance curve by means of the phase characteristics of the signal, so that it can accurately identify the events even when the signal-to-noise ratio of the digital signal is low, and provide an accurate basis for subsequent digital signal processing and analyzing.

According to one aspect of the present disclosure, a method for determining an identification threshold for identifying events (such as but not limited to syncphase axis) of digital signal is provided, which comprises:

performing Hilbert transform on a random noise signal trace gather;

deriving a cosine phase function trace gather of the random noise signal trace gather;

deriving an identification threshold function for events from the cosine phase function trace gather, wherein a variable parameter of the identification threshold function is the total number of the signal traces (i.e. a number of times of overlaying).

According to another aspect of the present disclosure, a method for identifying events of digital signal is provided, which comprises:

performing Hilbert transform on a random noise signal trace gather;

calculating a cosine phase function trace gather of the random noise signal trace gather;

deriving an identification threshold function for events from the cosine phase function trace gather, wherein a variable parameter of the identification threshold function is the total number of the signal traces;

inputting digital signal trace gather to be identified;

at each time sampling point, a function value obtained by horizontally stacking the cosine phase function trace gathers of the inputted digital signal trace gather is compared with an identification threshold function value obtained when the value of the variable parameter of the identification threshold function for the events is set to be the total number of the signal traces comprised in the inputted digital signal trace gather;

the time sampling points at which the function value obtained by horizontally stacking the cosine phase function trace gathers of the inputted digital signal trace gather is greater than the identification threshold function value are identified as having events.

According to yet another aspect of the present disclosure, a method for identifying events of digital signal is provided, which comprises:

inputting digital signal trace gather to be identified;

performing Hilbert transform on the inputted digital signal trace gather;

deriving a cosine phase function trace gather of the inputted digital signal trace gather;

horizontally stacking the cosine phase function trace gathers of the inputted digital signal trace gather so as to obtain, at each time sampling point, a function value of the horizontally stacked cosine phase function trace gathers of the inputted digital signal trace gather;

the function values obtained at each time sampling point are compared with a function value of an identification threshold function for events, wherein the identification threshold function for events is obtained by horizontally stacking the cosine phase function trace gathers of random noise trace gather, and a variable parameter of the identification threshold function is the total number of the signal traces;

the time sampling points at which the function value obtained by horizontally stacking the cosine phase function trace gathers of the input digital signal trace gather to be identified is greater than the function value of the identification threshold function for the events are identified as having events.

According to another aspect of the present disclosure, a device for determining an identification threshold for identifying events of digital signal is provided, which comprises:

unit to perform Hilbert transform on a random noise signal trace gather;

unit to derive a cosine phase function trace gather of the random noise signal trace gather; and

unit to derive an identification threshold function for events from the cosine phase function trace gather, wherein a variable parameter of the identification threshold function is the total number of the signal traces.

According to still another aspect of the present disclosure, a system for identifying events of digital signal is provided, which comprises:

unit to input digital signal trace gather to be identified;

unit to perform Hilbert transform on the inputted digital signal trace gather;

unit to derive a cosine phase function trace gather of the inputted digital signal trace gather;

unit to horizontally stack the cosine phase function trace gathers of the inputted digital signal trace gather so as to obtain, at each time sampling point, a function value of the horizontally stacked cosine phase function trace gathers of the input digital signal trace gather;

unit to compare the function values obtained at each time sampling point with a function value of an identification threshold function for events, wherein the identification threshold function for events is obtained by horizontally stacking the cosine phase function trace gathers of random noise trace gather, and a variable parameter of the identification threshold function is the total number of the signal traces;

unit to identify the time sampling points at which the function value obtained by horizontally stacking the cosine phase function trace gathers of the input digital signal trace gather to be identified is greater than the function value of the identification threshold function for the events, as having events.

According to still anther aspect of the present disclosure, a computer-readable storage medium carrying a set of instructions that when executed by a computer cause the computer to carry out a method is provided, wherein the method comprises:

inputting digital signal trace gather to be identified;

performing Hilbert transform on the inputted digital signal trace gather;

deriving a cosine phase function trace gather of the inputted digital signal trace gather;

horizontally stacking the cosine phase function trace gathers of the input digital signal trace gather so as to obtain, at each time sampling point, a function value of the horizontally stacked cosine phase function trace gathers of the input digital signal trace gather;

the function values obtained at each time sampling point are compared with a function value of an identification threshold function for events, wherein the identification threshold function for events is obtained by horizontally stacking the cosine phase function trace gathers of random noise trace gather, and a variable parameter of the identification threshold function is the total number of the signal traces;

the time sampling points at which the function value obtained by horizontally stacking the cosine phase function trace gathers of the input digital signal trace gather to be identified is greater than the function value of the identification threshold function for the events are identified as having events.

The present disclosure can be widely used to accurately identify and track digital signals in the art of digital signal processing, such as electronic information processing, communication signal processing, and physical geographic signal processing (especially seismic prospecting data processing), and so on.

### BRIEF DESCRIPTION OF THE DRAWINGS

The accompanying drawings illustrate several examples of the disclosure and, together with the description, serve to explain the principles of the invention. One skilled in the art will recognize that the particular examples illustrated in the drawings are merely exemplary, and are not intended to limit the scope of the present invention. It will be appreciated that in some examples one element may be designed as multiple elements or that multiple elements may be designed as one element. In some examples, an element shown as an internal component of another element may be implemented as an external component and vice versa. In order to describe the exemplary examples of the present disclosure in further detail, reference will now be made to the appended figures, so that the aspects, features and advantages of the present disclosure will be understood more thoroughly. In the figures:

FIG. 1A illustrates a flow chart of an exemplary method for determining an identification threshold for identifying events of digital signal according to the present disclosure;

FIG. 1B illustrates a flow chart of an exemplary method for identifying events of digital signal (for example but not limited to a digital signal with low signal-to-noise ratio) according to the present disclosure;

FIG. 2 is a schematic diagram illustrating a contrast between a real number field theoretical model and a phase field theoretical model thereof;

FIG. 3 is a schematic diagram illustrating a contrast between a real number field theoretical model for single trace and a phase field theoretical model for single trace thereof;

FIG. 4 is a schematic diagram illustrating an axis of stacked wave crest value;

FIG. 5 is a schematic diagram illustrating a statistics of thresholds values for identifying events of digital signal (for example but not limited to a digital signal with low signal-to-noise ratio) according to the present disclosure;

FIG. 6 is a schematic diagram illustrating a velocity spectrum of an input digital signal trace gather (wherein events identified by employing the method according to the present disclosure is shown in the velocity spectrum) as well as time cross-sections of the input digital signal trace gather, a normal moveout corrected signal trace gather, and adjacent trace gathers that are horizontally stacked;

FIG. 7A illustrates a schematic block diagram of a device for determining an identification threshold for identifying events of digital signal according to the present disclosure; and

FIG. 7B illustrates a schematic block diagram of an exemplary system for identifying events of digital signal (for example but not limited to a digital signal with low signal-to-noise ratio) according to the present disclosure.

### DETAILED DESCRIPTION

Some terms are used for denoting specific system components throughout the application document. As would be appreciated by those skilled in the art, different designations may usually be used for denoting the same component, thus the application document does not intend to distinguish those components that are only different in name rather than in function. In the application document, terms “comprise”, “include” and “have” are used in the opening way, and thus they shall be construed as meaning “comprise but not limited to . . . ”. Besides, Terms “substantially”, “essentially”, or “approximately”, that may be used herein, relate to an industry-accepted tolerance to the corresponding term. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

In the following description, for the purpose of explanation, many specific details are set forth so as to provide a thorough understanding of the disclosure. However, it is apparent for those skilled in the art that the apparatus, method and device of the present disclosure may be implemented without those specific details. The reference to the “embodiment”, “example” or similar language in the Description means that the specific features, structures or characteristics described in connection with the embodiment or example are comprised in at least said embodiment or example, but are not necessarily comprised in other embodiments or examples. Various instances of the phrases of “in an embodiment”, “in a preferred embodiment” or similar phrase in different portions of the Description do not necessarily all refer to the same embodiment.

In order to facilitate a thorough understanding of the technical solution of the present disclosure, some characteristics of the events in signals with low signal-to-noise ratio will be briefly introduced herein by taking the seismic signals as an example. However, the seismic signals mentioned herein are only examples for illustrating the technical solution of the present disclosure, and they do not intend to limit the scope of the present disclosure.

During seismic prospecting, when the surface and under-ground geological structures are complicated, the captured seismic signals will have a low signal-to-noise ratio. Under such a circumstance, a great deal of seismic signals is overshadowed by noises, and the events of the seismic signals are almost invisible on the seismic profile, or only some of the events are indistinctly visible. Then, the events (such as but not limited to syncphase axis) appear twisted, incontinuity, out-of-phase (disappearance of in-phase), signal energy jump between traces, and weak signals invisible to the naked eye, and so on.

As mentioned previously, there are many methods for identifying events in the prior art, but so far, in most cases there is no way to identify the events of signals with low signal-to-noise ratio. The inventor of the present disclosure discovers that the events mainly depends on the signal phase, and this is the key point.

In digital signals with low signal-to-noise ratio, the signals can be considered as either random noises or events. That is to say, the upper identification threshold for random noises should be considered as the lower identification threshold for events of digital signal. Therefore, if the upper identification threshold for random noises can be obtained, the events of signals with low signal-to-noise ratio can be identified and tracked.

In addition, although there are infinite forms of random noises, synthesizing the random noises trace gather is much simpler than synthesizing the events trace gather of signals with low signal-to-noise ratio, so the novel idea of the present disclosure is operable and applicable.

The present disclosure will be described in detail in combination with each drawings.

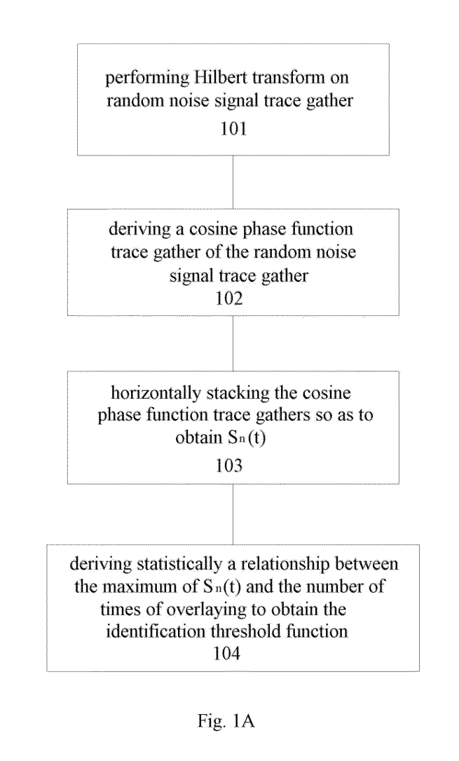

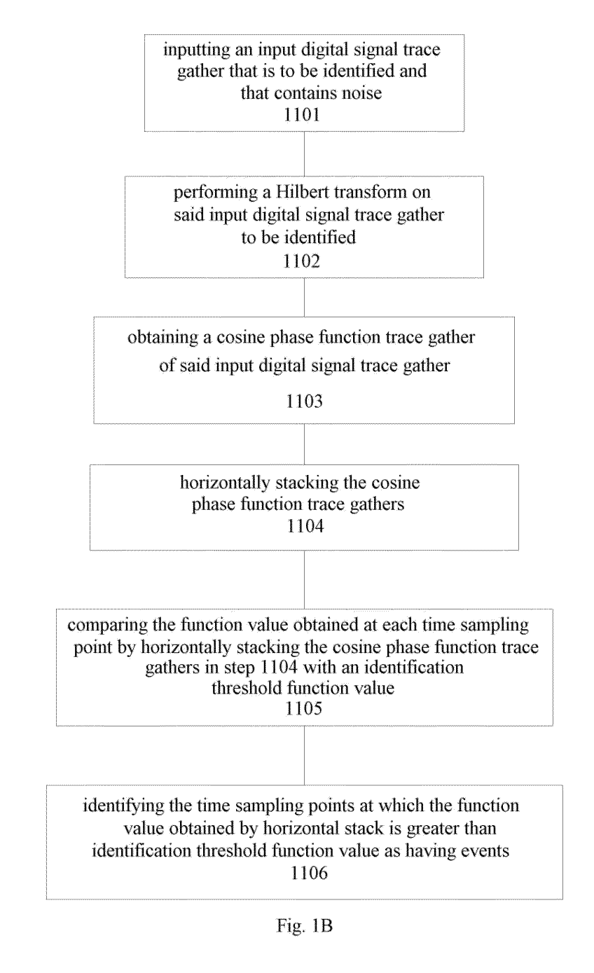

FIG. 1A of the present disclosure illustrates a flow chart of an exemplary method for determining an identification threshold for identifying events of digital signal according to the present disclosure. FIG. 1B illustrates a flow chart of an exemplary method for identifying events of digital signal (for example but not limited to a digital signal with low signal-to-noise ratio) according to the present disclosure;

Generally speaking, the exemplary method for identifying events according to the present disclosure mainly involves identifying the events (such as but not limited to syncphase axis) of a digital signal with low signal-to-noise ratio based on a known time-distance curve in phase domain by means of the characteristic that the events of a digital signal (for example but not limited to seismic data signal trace gather) basically depend on the signal phase.

The time-distance curve mentioned herein refers to a curve of a relation between seismic travel time and distance, namely, a curve of a relation between the time at which a seismic wave reaches each of the demodulator probes and the distances from the demodulator probes to the shot points.

As can be understood by those skilled in the art, one important aspect of the present disclosure lies in obtaining an identification threshold function for events (such as but not limited to syncphase axis), which mainly comprises: performing Hilbert transform on the random noise trace gather (containing only the random noise) to derive a cosine phase function trace gather of the random noise trace gather; then stacking the cosine phase function trace gathers of the random noise trace gather horizontally (i.e. horizontally stacking all signal traces into one signal trace) according to the characteristics that the phase function only reflects the phase and frequency of the signal and is irrelevant to the amplitude of the signal and that the range of the amplitude is [−1, 1], so as to obtain a relationship between the maximum of the signal wave peak and a number of times of overlaying (i.e. a total number of signal traces), and thereby deriving statistically an upper identification threshold function for the random noise (i.e. an identification threshold function for events) that varies with the number of times of overlaying.

The identification threshold function for events according to the present disclosure is provided in the form of an empirical formula. Such an empirical formula can be directly used.

As shown in FIG. 1A, in step 101, Hilbert transform is performed on the random noise signal trace gather xᵢ(t) to obtain Hilbert-transformed hᵢ(t), said Hilbert transform is represented by:

$${h}_{i} ( t ) = \frac{1}{π} {\int }_{- ∞}^{+ ∞} \frac{{x}_{i} ( t )}{t - τ} d τ \qquad ( 1 )$$

wherein t represents time, i represents the sequence number of signal traces, and τ represents a sampling point in each signal trace.

In step 102, a cosine phase function trace gather cos θᵢ(t) of the random noise signal trace gather xᵢ(t) is derived, said cosine phase function trace gather can be derived as follows:

firstly, deriving an instantaneous envelope of the random noise signal trace gather xᵢ(t), said instantaneous envelope being expressed as:

aᵢ(t)=\sqrt{xᵢ²(t)+hᵢ²(t)} (2)

secondly, deriving an instantaneous phase from the instantaneous envelope, said instantaneous phase being expressed as:

$${θ}_{i} ( t ) = arccos ( \frac{{x}_{i} ( t )}{{a}_{i} ( t )} ) \qquad ( 3 )$$

thus the cosine phase function trace gather is:

$$\begin{matrix}cos {θ}_{i} ( t ) = \frac{{x}_{i} ( t )}{{a}_{i} ( t )} \\ thus , & ( 4 ) \\ {x}_{i} ( t ) = cos {θ}_{i} ( t ) \cdot {a}_{i} ( t ) & ( 5 )\end{matrix}$$

It can be seen from equation (5) that xᵢ(t) can be decomposed into cosine phase function cos θᵢ(t) and an instantaneous envelope aᵢ(t).

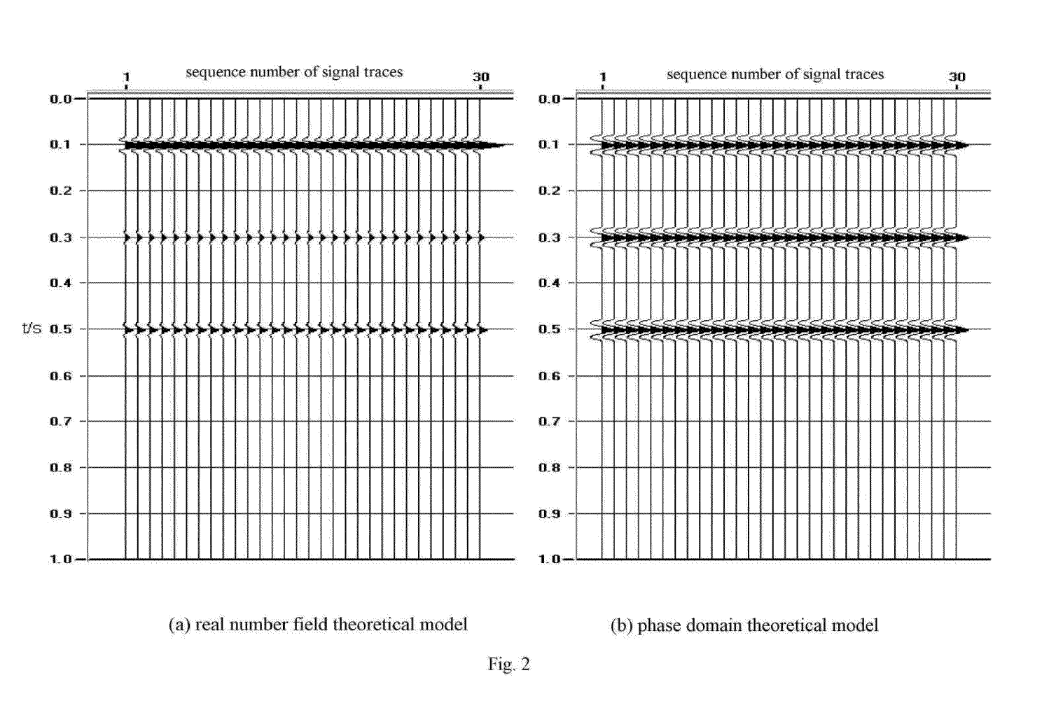

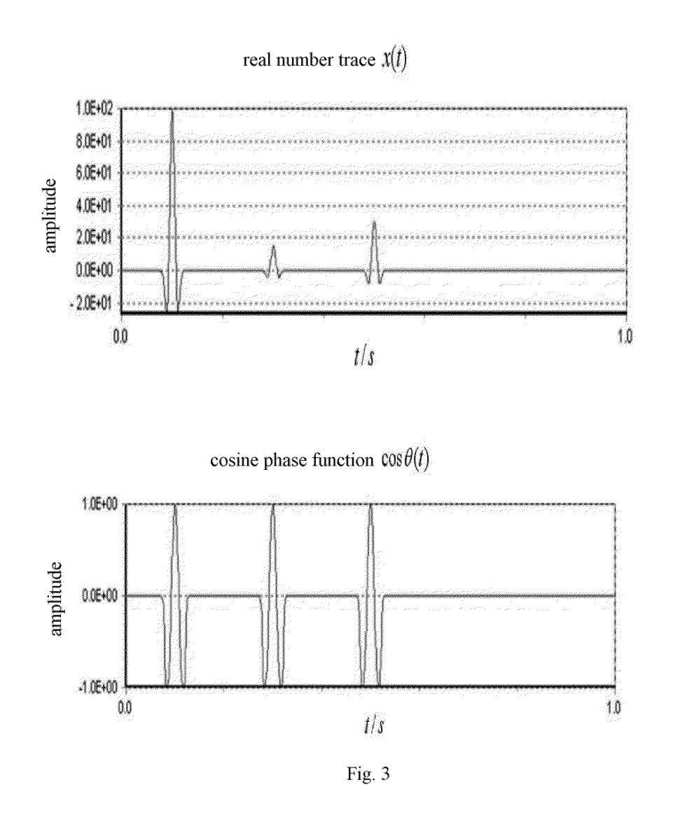

It can be seen from equation (4) that the cosine phase function cos θᵢ(t) only reflects the phase and frequency of the signal, and the amplitude range thereof is [−1, 1]. As shown in FIG. 2 showing a cross section of the signal trace gather and FIG. 3 showing a single signal trace, the cosine phase function of the signal is only relevant to the phase and frequency of the signal, while the amplitudes are within the range of [−1, 1].

In step 103, the derived cosine phase function trace gathers are horizontally stacked according to the characteristics as shown in FIG. 3 that the cosine phase function only reflects the phase and frequency of the signal and is irrelevant to the amplitude of the signal and that the range of the amplitude is [−1, 1], so as to obtain Sₙ(t) represented by:

$${S}_{n} ( t ) = \frac{1}{n} {\sum }_{i = 1}^{n} cos {θ}_{i} ( t ) \qquad ( 6 )$$

In equation (6), n represents the number of times of overlaying (i.e. a total number of signal traces), i represents sequence number of signal traces), and t represents time.

In step 104, deriving statistically a relationship between the maximum of Sₙ(t) and the number of times of overlaying (i.e. the total number of signal traces), and deriving an empirical formula (e.g. equation (8) described below) of the identification threshold function for events that varies with the total number of signal traces.

The exemplary empirical formula of the identification threshold function for events (such as but not limited to syncphase axis) according to the present disclosure can be derived as follows:

Suppose that tₚ is the time at which a signal wave peak occurs, then ideal events can be defined as:

Sₙ(tₚ)=1 (7)

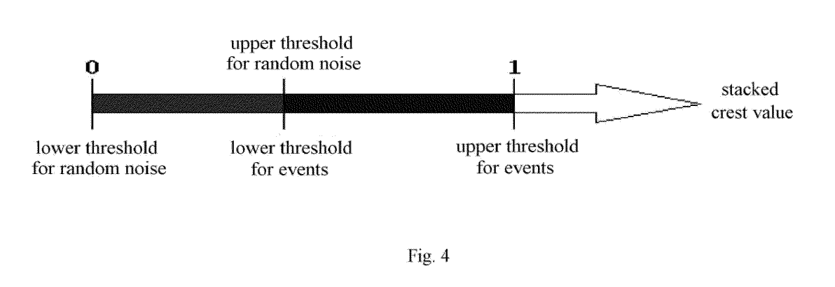

The defined value of the ideal events herein is the upper identification threshold for the events. As shown in FIG. 4, there are three points in the axis of stacked wave crest values, among which two have been acquired, i.e. the lower threshold of a random noise and the upper threshold of events, while the other point that is the most important is the lower threshold for events of a signal (e.g. a signal with low signal-to-noise), wherein the lower threshold for events of a signal is also called “identification threshold for identifying events”).

Suppose that S̅ₙ(tₚ) represents the identification threshold for identifying events of a signal, then it can be seen clearly from FIG. 4 that 0< S̅ₙ(tₚ)<1.

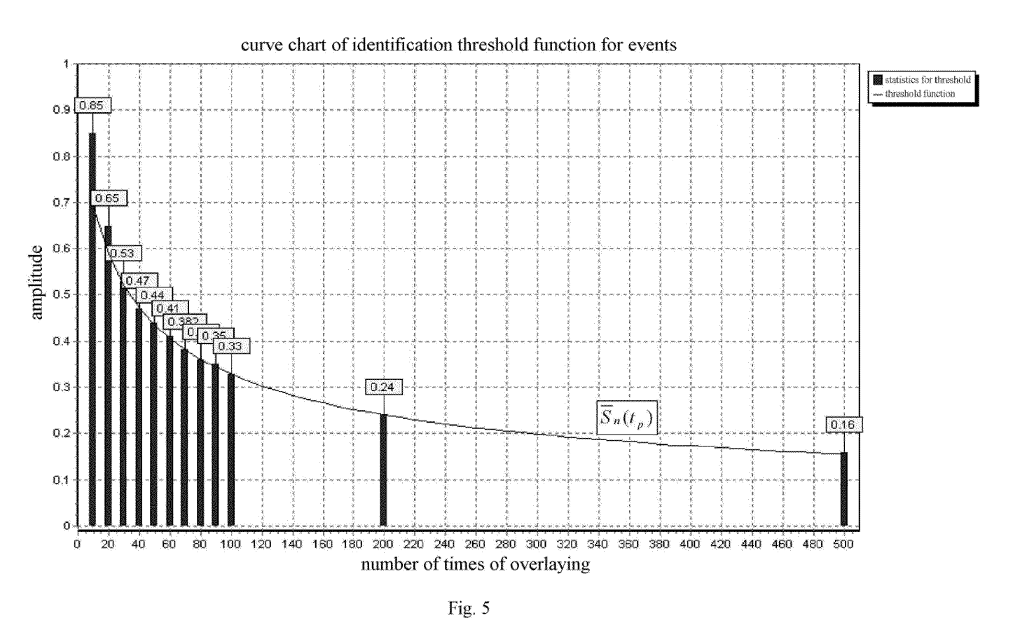

FIG. 5 is a schematic diagram illustrating a statistics of identification threshold function S̅ₙ(tₚ). It can be seen FIG. 5 that S̅ₙ(tₚ) is inversely proportional to the number of times of overlaying (i.e. the total number of signal traces).

Thus an exemplary empirical formula of an identification threshold function for events which varies with the number of times of overlaying can be obtained as follows:

$${\overline{S}}_{n} ( {t}_{p} ) = \frac{5 μ}{\sqrt{2 n + 32}} \qquad ( 8 )$$

wherein n represents the number of times of overlaying (i.e. total number of signal traces), μ represents an adjustment coefficient, preferably 0.5≦μ≦1.0, and more preferably, μ is 0.618.

When n and μ are given, S̅ₙ(tₚ) is a constant.

It shall be noted herein that said empirical formula is merely an example of the present disclosure, and the scope of the present application is not limited thereto. Other empirical formula of the identification threshold function for events which varies with the number of times of overlaying can be derived statistically by those skilled in the art without departing from the spirit and scope of the present disclosure, and such further modified empirical formulas fall within the scope of the present application.

In the description below, an exemplary method for identifying the events of an input digital signal to be identified (such as but not limited to a digital signal with low signal-to-noise ratio) by employing the above-mentioned identification threshold function for events will be illustrated in detail with respect to FIG. 1B.

As shown in FIG. 1B, in step 1101, an input digital signal trace gather that is to be identified and that contains noise is input.

In step 1102, Hilbert transform is performed on said input digital signal trace gather to be identified according to the above equation (1).

In step 1103, a cosine phase function trace gather of said input digital signal trace gather to be identified is calculated according to the above equations (2), (3) and (4).

In step 1104, the cosine phase function trace gathers of said input digital signal trace gather are horizontally stacked (i.e. horizontally stacking all signal trace into one trace) so as to obtain, at each time sampling point, a function value of the horizontally stacked cosine phase function trace gathers of the input digital signal trace gather.

In step 1105, at each time sampling point, a function value obtained by horizontally stacking the cosine phase function trace gathers of the input digital signal trace gather is compared with an identification threshold function value obtained when the value of the variable parameter n of the identification threshold function for the events is set to be the total number of the signal traces comprised in the input digital signal trace gather. For example, if the total number of signal traces comprised in the input digital signal trace gather to be identified is 30, then the variable parameter n of said identification threshold function S̅ₙ(tₚ) is set to be 30, and the identification threshold function value is derived from such a value of 30.

In step 1106, the time sampling points at which the function value obtained by horizontally stacking the cosine phase function trace gathers of the input digital signal trace gather to be identified is greater than the function value of the identification threshold function for the events are identified as having events, otherwise, the time sampling point in question is identified as having noise.

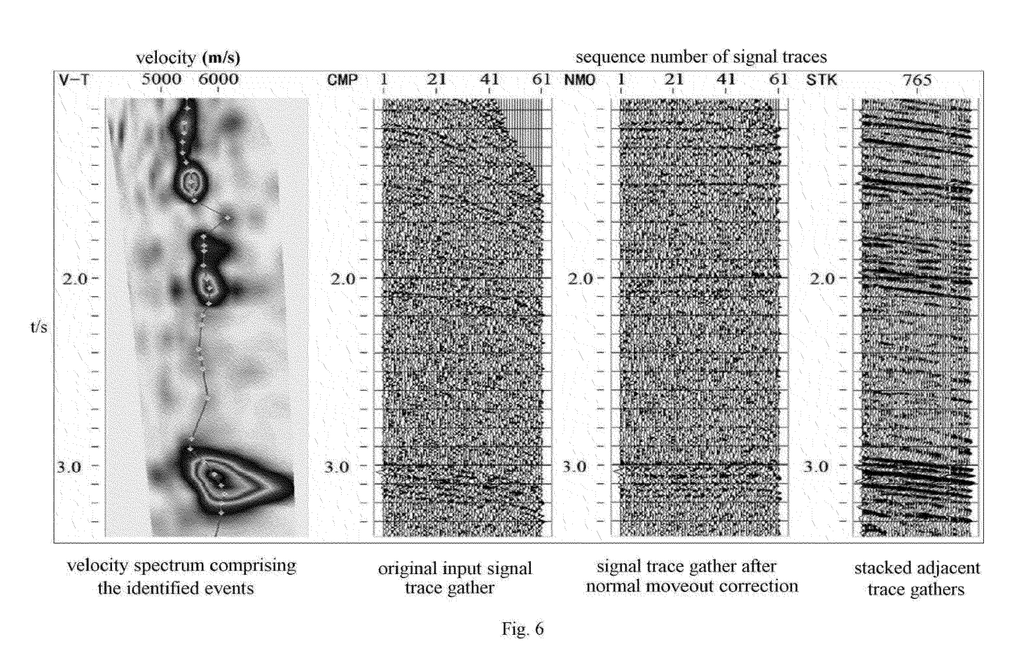

FIG. 6 is a schematic diagram illustrating a velocity spectrum of an input digital signal trace gather of a real CMP signal trace gather (wherein events identified by employing the method according to the present disclosure is shown in the velocity spectrum) as well as time cross-sections of the input digital signal trace gather, a normal moveout corrected signal trace gather, and adjacent trace gathers that are horizontally stacked. It can be seen from some region in the cross sections in FIG. 6 that the result of identification of the events is correct.

Further, an exemplary system for identifying events of digital signal according to the present disclosure will be described below in detail.

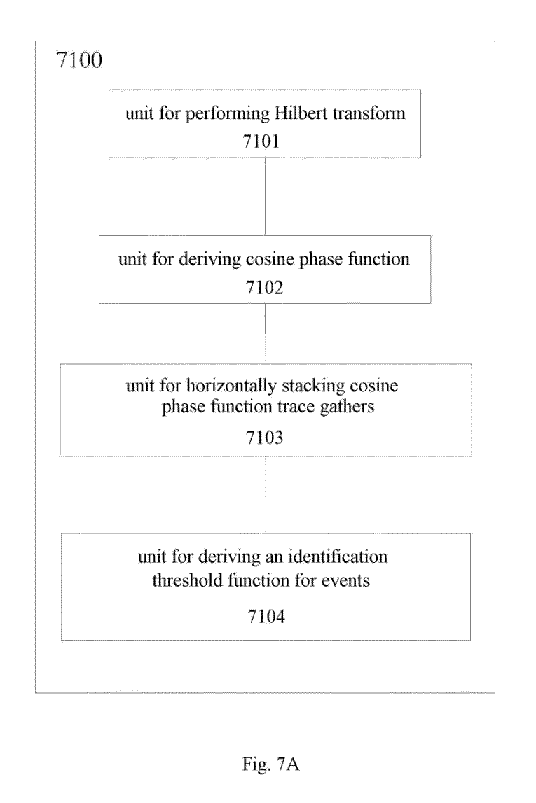

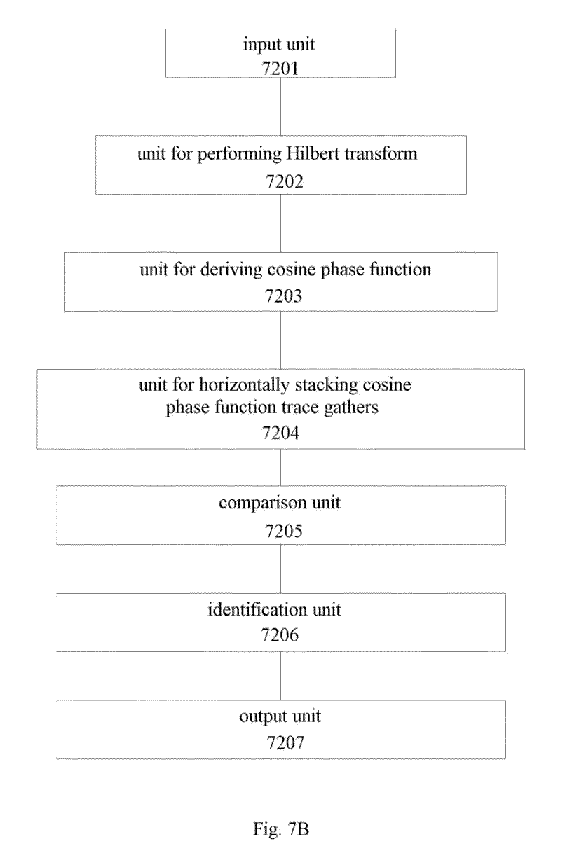

FIG. 7A illustrates a schematic block diagram of a device for determining an identification threshold for identifying events of digital signal according to the present disclosure.

As shown in FIG. 7A, the device 7100 for determining an identification threshold for identifying events of digital signal comprises but not limited to: a unit 7101 for performing Hilbert transform, a unit 7102 for deriving cosine phase function, a unit 7103 for horizontally stacking cosine phase function trace gathers, and a unit 7104 for deriving an identification threshold function for events.

The unit 7101 for performing Hilbert transform is configured to perform Hilbert transform on a random noise signal trace gather.

The unit 7102 is coupled to the unit 7101 and is configured to calculating the cosine phase function trace gather of the random noise signal trace gather.

The unit 7103 horizontally stack the cosine phase function trace gathers obtained by the unit 7102 according to the characteristics as shown in FIG. 3 that the cosine phase function only reflects the phase and frequency of the signal and is irrelevant to the amplitude of the signal and that the range of the amplitude is [−1, 1], so as to obtain Sₙ(t) by means of the equation (6) above.

The unit 7104 is configured to derive statistically a relationship between the maximum of Sₙ(t) and the number of times of overlaying, and to obtain the identification threshold function for events that varies with the number of times of overlaying (e.g. the equation (8) above).

FIG. 7B is a schematic block diagram of an exemplary system for identifying events of digital signal (such as but not limited to a digital signal with low signal-to-noise ratio) according to the present disclosure.

As shown in FIG. 7B, the system comprises but not limited to an input unit 7201, a unit 7202 for performing Hilbert transform, a unit 7203 for deriving cosine phase function, a unit 7204 for horizontally stacking cosine phase function trace gathers, a comparison unit 7205, an identification unit 7206 and an output unit 7207.

The input unit 7201 is configured to input an input signal trace gather that is to be identified and that contains noise.

The unit 7202 is configured to perform Hilbert transform on the input signal trace gather according to the above equation (1).

The unit 7203 is coupled to the unit 7202 and is configured to calculate a cosine phase function trace gather of said input digital signal trace gather according to the above equations (2), (3) and (4).

The unit 7204 is coupled to the unit 7203 and is configured to stack the cosine phase function trace gather of said input digital signal trace gather horizontally (i.e. horizontally stacking all trace into one trace) so as to obtain, at each time sampling point, a function value of the horizontally stacked cosine phase function trace gathers of the input digital signal trace gather.

The comparison unit 7205 is coupled to the unit 7204 and to the device 7100 as shown in FIG. 7A, and is configured to compare, at each time sampling point, a function value obtained by horizontally stacking the cosine phase function trace gathers of the input digital signal trace gather with an identification threshold function value obtained when the value of the variable parameter n of the identification threshold function for the events is set to be the total number of the signal traces comprised in the input digital signal trace gather to be identified.

The identification unit 7206 is configured to identify the time sampling points at which the function value obtained by horizontally stacking the cosine phase function trace gathers of the input digital signal trace gather to be identified is greater than the function value of the identification threshold function for the events, as having events; otherwise, the time sampling point in question is identified as having noise.

The output unit 7207 outputs the result of identification. Said output unit 7207 comprises but is not limited to a display unit, voice output unit such as a speaker, or any type of output unit that can enable the user to learn the result of identification.

In addition, it shall also be noted that the above examples in the present disclosure are only with respect to identification of horizontal events. If the events are not horizontal, horizontal events can be obtained by time-distance equation scanning, and then identification of the events is performed according to the above-mentioned method.

The present disclosure has been described in particular detail with respect to one possible embodiment. Those skilled in the art will appreciate that the invention may be practiced in other embodiments. The preferred examples of the disclosure may be implemented in any one of or the combination of hardware, software, firmware. In the various example(s), the device components are implemented by software or firmware stored in the memory and executed by an appropriate instruction execution system. If it is implemented in hardware, for example in some examples, the device components may be implemented by any one of or the combination of the following techniques well-known by those skilled in the art: discrete logic circuit(s) having a logic gate for performing logic function on data signals, an application-specific integrated circuit (ASIC) comprising an appropriate combinational logic gate, programmable gate array(s) (PGA), a field-programmable gate array (FPGA) and so on. Also, the particular division of functionality between the various system components described herein is merely exemplary, and not mandatory; functions performed by a single system component may instead be performed by multiple components, and functions performed by multiple components may instead be performed by a single component.

Software components may include an ordered list of the executable instructions for performing logic function, which may be embodied in any computer readable medium to be used by or in connection with an instruction execution system, apparatus or device. Said instruction execution system, apparatus or device is, for example, a computer-based system, a system containing a processor, or other system that can obtain instructions from the instruction execution system, apparatus or device and can execute said instructions. Besides, the scope of the present disclosure includes a function of embodying one or more embodiments in the logic embodied in the medium composed of hardware or software.

The embodiments of the present disclosure have been disclosed for the purpose of illustration. They do not intend to be exhaustive or restrict the present disclosure to the disclosed precise forms. According to the disclosure above, many variations and modifications of the embodiments herein are apparent for those skilled in the art. It is noted that the above examples do not intend to be restrictive. Additional embodiments of apparatuses, methods and devices comprising many of the aforesaid features may be further anticipated. The other apparatuses, methods, devices, features and advantages of the present disclosure are even more apparent to those skilled in the art after making reference to the detailed description and accompany figures. It is intended that all of such other apparatuses, methods, devices, features and advantages are included in the protection scope of the invention.

Unless specified otherwise, conditional languages such as “be able to”, “can”, “possibly”, “may” and the like generally intend to indicate that some embodiments may but not necessarily comprise some features, elements and/or steps. Therefore, such conditional languages generally do not intend to give a hint for requiring that one or more embodiments have to comprise features, elements and/or steps.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Further, the computers referred to herein may include a single processor or may be architectures employing multiple processor designs for increased computing capability.

The algorithms and displays presented herein are not inherently related to any particular computer, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description above. In addition, the present disclosure is not described with reference to any particular programming language. It will be appreciated that a variety of programming languages may be used to implement the teachings of the present disclosure as described herein, and any references above to specific languages are provided for disclosure of enablement and best mode of the present disclosure.

While the disclosure has been described with respect to a limited number of embodiments, those skilled in the art, having benefit of the above description, will appreciate that other embodiments may be devised which do not depart from the scope of the present disclosure as described herein. In addition, it should be noted that the language used in the specification has been principally selected for readability and instructional purposes, and may not have been selected to delineate or circumscribe the inventive subject matter. Accordingly, the disclosure of the present disclosure is intended to be illustrative, but not limiting, of the scope of the disclosure, which is set forth in the claims.

What is claimed is:

1. A method for determining an identification threshold for identifying events of digital signal, which comprises:
performing Hilbert transform on a random noise signal trace gather;
deriving a cosine phase function trace gather of the random noise signal trace gather;
deriving an identification threshold function for events from the cosine phase function trace gather, wherein a variable parameter of the identification threshold function is the total number of the signal traces.

2. The method of claim 1, wherein the step of deriving an identification threshold function for events further comprises:
horizontally stacking the cosine phase function trace gathers.

3. The method of claim 2, wherein the step of deriving an identification threshold function for events further comprises:
deriving statistically a relationship between a maximum of Sₙ(t) obtained by horizontally stacking the cosine phase function trace gathers and the total number of signal traces so as to obtain the identification threshold function for events that varies with the total number of signal traces.

4. The method of claim 1, wherein, the identification threshold function for events is represented by:
$${\overline{S}}_{n} ( {t}_{p} ) = \frac{5 μ}{\sqrt{2 n + 32}}$$
wherein, n represents the total number of signal traces, tₚ represents the time at which a signal peak occurs, μ represents an adjustment coefficient having a range of 0.5≦μ≦1.0.

5. The method of claim 4, wherein μ is 0.618.

6. A method for identifying events of digital signal, which comprises:
inputting digital signal trace gather to be identified;
performing Hilbert transform on the inputted digital signal trace gather;
deriving a cosine phase function trace gather of the inputted digital signal trace gather;
horizontally stacking the cosine phase function trace gathers of the inputted digital signal trace gather so as to obtain, at each time sampling point, a function value of the horizontally stacked cosine phase function trace gathers of the inputted digital signal trace gather;
the function values obtained at each time sampling point are compared with a function value of an identification threshold function for events, wherein the identification threshold function for events is obtained by horizontally stacking the cosine phase function trace gathers of random noise trace gather, and a variable parameter of the identification threshold function is the total number of the signal traces;
the time sampling points at which the function value obtained by horizontally stacking the cosine phase function trace gathers of the inputted digital signal trace gather to be identified is greater than the function value of the identification threshold function for the events are identified as having events.

7. The method of claim 6, wherein the identification threshold function for events is obtained by deriving statistically a relationship between a maximum of Sₙ(t) obtained by horizontally stacking the cosine phase function trace gathers of random noise trace gather and the total number of signal traces.

8. The method of claim 6, wherein, the identification threshold function for events is represented by:
$${\overline{S}}_{n} ( {t}_{p} ) = \frac{5 μ}{\sqrt{2 n + 32}}$$
wherein, n represents the total number of signal traces, tₚ represents the time at which a signal peak occurs, μ represents an adjustment coefficient having a range of 0.5≦μ≦1.0.

9. The method of claim 8, wherein μ is 0.618.

10. The method of claim 6, wherein the inputted digital signal trace gather is a seismic digital signal trace gather.

11. The method of claim 10, wherein the inputted digital signal trace gather has low signal-to-noise ratio.

12. A system, which comprises:
a memory; and
a processor coupled to the memory;
wherein the memory comprises a set of instructions for causing the processor to perform the steps of:
inputting digital signal trace gather to be identified;
performing Hilbert transform on the inputted digital signal trace gather;
deriving a cosine phase function trace gather of the inputted digital signal trace gather;
horizontally stacking the cosine phase function trace gathers of the inputted digital signal trace gather so as to obtain, at each time sampling point, a function value of the horizontally stacked cosine phase function trace gathers of the inputted digital signal trace gather;
the function values obtained at each time sampling point are compared with a function value of an identification threshold function for events, wherein the identification threshold function for events is obtained by horizontally stacking the cosine phase function trace gathers of random noise trace gather, and a variable parameter of the identification threshold function is the total number of the signal traces;
the time sampling points at which the function value obtained by horizontally stacking the cosine phase function trace gathers of the inputted digital signal trace gather to be identified is greater than the function value of the identification threshold function for the events are identified as having events.

13. The system of claim 12, wherein the identification threshold function for events is obtained by deriving statistically a relationship between a maximum of Sₙ(t) obtained by horizontally stacking the cosine phase function trace gathers of random noise trace gather and the total number of signal traces.

14. The system of claim 12, wherein the identification threshold function for events is represented by:
$${\overline{S}}_{n} ( {t}_{p} ) = \frac{5 μ}{\sqrt{2 n + 32}}$$
wherein, n represents the total number of signal traces, tₚ represents the time at which a signal peak occurs, μ represents an adjustment coefficient having a range of 0.5≦μ≦1.0.

15. The system of claim 14, wherein μ is 0.618.

16. The system of claim 12, wherein the inputted digital signal trace gather is a seismic digital signal trace gather.

17. The system of claim 16, wherein the inputted digital signal trace gather has low signal-to-noise ratio.

18. Computer-readable storage medium carrying a set of instructions that when executed by a computer cause the computer to carry out a method comprising the step of:
inputting digital signal trace gather to be identified;
performing Hilbert transform on the inputted digital signal trace gather;
deriving a cosine phase function trace gather of the inputted digital signal trace gather;
horizontally stacking the cosine phase function trace gathers of the inputted digital signal trace gather so as to obtain, at each time sampling point, a function value of the horizontally stacked cosine phase function trace gathers of the inputted digital signal trace gather;
the function values obtained at each time sampling point are compared with a function value of an identification threshold function for events, wherein the identification threshold function for events is obtained by horizontally stacking the cosine phase function trace gathers of random noise trace gather, and a variable parameter of the identification threshold function is the total number of the signal traces;
the time sampling points at which the function value obtained by horizontally stacking the cosine phase function trace gathers of the inputted digital signal trace gather to be identified is greater than the function value of the identification threshold function for the events are identified as having events.
